(19) United States
(12) Patent Application Publication
(10) Pub. No.: US 2025/0150966 A1
(43) Pub. Date: May 8, 2025

(54) ENERGY HARVESTING DURATION

(71) Applicant: QUALCOMM Incorporated, San Diego, CA (US)

(72) Inventors: Ahmed ELSHAFIE, San Diego, CA (US); Yuchul KIM, San Diego, CA (US); Linhai HE, San Diego, CA (US); Seyedkianoush HOSSEINI, San Diego, CA (US); Huilin XU, Temecula, CA (US); Zhikun WU, Beijing (CN)

(21) Appl. No.: 18/727,401

(22) PCT Filed: Mar. 23, 2022
(86) PCT No.: PCT/CN2022/082447

§ 371 Date: Jul. 9, 2024

(51) Int. Cl. H04W 52/02; H04W 76/28

(52) U.S. Cl. CPC H04W 52/0216; H04W 52/0229; H04W 52/028; H04W 76/28

(57) ABSTRACT

Various aspects of the present disclosure generally relate to wireless communication. In some aspects, an energy harvesting (EH) device may receive a discontinuous reception (DRX) configuration that indicates a DRX on-duration for data communication and an EH configuration that indicates a reserved EH duration during which the first device harvests energy and does not transmit or receive data. The DRX on-duration and the reserved EH duration may be part of a periodic cycle. The EH device may perform data communication during the DRX on-duration. The EH device may switch one or more antennas of the first device to an EH mode and perform EH during the reserved EH duration. Numerous other aspects are described.

### FIELD OF THE DISCLOSURE

Aspects of the present disclosure generally relate to wireless communication and to techniques and apparatuses for using an energy harvesting duration.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a first device (e.g., an energy harvesting (EH) device). The method may include receiving a discontinuous reception (DRX) configuration that indicates a DRX on-duration for data communication and an EH configuration that indicates a reserved EH duration during which the first device harvests energy and does not transmit or receive data, where the DRX on-duration and the reserved EH duration are part of a periodic cycle. The method may include performing data communication during the DRX on-duration. The method may include switching one or more antennas of the first device to an EH mode. The method may include performing EH during the reserved EH duration.

Some aspects described herein relate to a method of wireless communication performed by a second device (e.g., a charging device, a network entity). The method may include transmitting a DRX configuration that indicates a DRX on-duration for data communication and an EH configuration that indicates a reserved EH duration during which a first device harvests energy and does not transmit or receive data, where the DRX on-duration and the reserved EH duration are part of a periodic cycle. The method may include performing data communication during the DRX on-duration. The method may include transmitting energy to the first device during the reserved EH duration.

Some aspects described herein relate to a method of wireless communication performed by a first device (e.g., an EH device). The method may include receiving a DRX configuration that indicates a DRX on-duration for data communication and an EH configuration that indicates an EH duration during which the first device harvests energy, where the DRX on-duration and the EH duration partially overlap or fully overlap. The method may include performing data communication during the DRX on-duration. The method may include splitting power of the first device to also perform EH during the EH duration.

Some aspects described herein relate to a method of wireless communication performed by a second device (e.g., a charging device, a network entity). The method may include transmitting a DRX configuration that indicates a DRX on-duration for data communication and an EH configuration that indicates an EH duration during which a first device harvests energy, where the DRX on-duration and the EH duration partially overlap or fully overlap. The method may include performing data communication during the DRX on-duration. The method may include transmitting energy during the EH duration.

Some aspects described herein relate to a first device for wireless communication. The first device may include a memory and one or more processors coupled to the memory. The one or more processors may be configured to receive a DRX configuration that indicates a DRX on-duration for data communication and an EH configuration that indicates a reserved EH duration during which the first device harvests energy and does not transmit or receive data, where the DRX on-duration and the reserved EH duration are part of a periodic cycle. The one or more processors may be configured to perform data communication during the DRX on-duration. The one or more processors may be configured to switch one or more antennas of the first device to an EH mode. The one or more processors may be configured to perform EH during the reserved EH duration.

Some aspects described herein relate to a second device for wireless communication. The second device may include a memory and one or more processors coupled to the memory. The one or more processors may be configured to transmit a DRX configuration that indicates a DRX on-duration for data communication and an EH configuration that indicates a reserved EH duration during which a first device harvests energy and does not transmit or receive data, where the DRX on-duration and the reserved EH duration are part of a periodic cycle. The one or more processors may be configured to perform data communication during the DRX on-duration. The one or more processors may be configured to transmit energy to the first device during the reserved EH duration.

Some aspects described herein relate to a first device for wireless communication. The first device may include a memory and one or more processors coupled to the memory. The one or more processors may be configured to receive a DRX configuration that indicates a DRX on-duration for data communication and an EH configuration that indicates an EH duration during which the first device harvests energy, where the DRX on-duration and the EH duration partially overlap or fully overlap. The one or more processors may be configured to perform data communication during the DRX on-duration. The one or more processors may be configured to split power of the first device to also perform EH during the EH duration.

Some aspects described herein relate to a second device for wireless communication. The second device may include a memory and one or more processors coupled to the memory. The one or more processors may be configured to transmit a DRX configuration that indicates a DRX on-duration for data communication and an EH configuration that indicates an EH duration during which a first device harvests energy, where the DRX on-duration and the EH duration partially overlap or fully overlap. The one or more processors may be configured to perform data communication during the DRX on-duration. The one or more processors may be configured to transmit energy during the EH duration.

Some aspects described herein relate to a non-transitory computer-readable medium that stores a set of instructions for wireless communication by a first device. The set of instructions, when executed by one or more processors of the first device, may cause the first device to receive a DRX configuration that indicates a DRX on-duration for data communication and an EH configuration that indicates a reserved EH duration during which the first device harvests energy and does not transmit or receive data, where the DRX on-duration and the reserved EH duration are part of a periodic cycle. The set of instructions, when executed by one or more processors of the first device, may cause the first device to perform data communication during the DRX on-duration. The set of instructions, when executed by one or more processors of the first device, may cause the first device to switch one or more antennas of the first device to an EH mode. The set of instructions, when executed by one or more processors of the first device, may cause the first device to perform EH during the reserved EH duration.

Some aspects described herein relate to a non-transitory computer-readable medium that stores a set of instructions for wireless communication by a second device. The set of instructions, when executed by one or more processors of the second device, may cause the second device to transmit a DRX configuration that indicates a DRX on-duration for data communication and an EH configuration that indicates a reserved EH duration during which a first device harvests energy and does not transmit or receive data, where the DRX on-duration and the reserved EH duration are part of a periodic cycle. The set of instructions, when executed by one or more processors of the second device, may cause the second device to perform data communication during the DRX on-duration. The set of instructions, when executed by one or more processors of the second device, may cause the second device to transmit energy to the first device during the reserved EH duration.

Some aspects described herein relate to a non-transitory computer-readable medium that stores a set of instructions for wireless communication by a first device. The set of instructions, when executed by one or more processors of the first device, may cause the first device to receive a DRX configuration that indicates a DRX on-duration for data communication and an EH configuration that indicates an EH duration during which the first device harvests energy, where the DRX on-duration and the EH duration partially overlap or fully overlap. The set of instructions, when executed by one or more processors of the first device, may cause the first device to perform data communication during the DRX on-duration. The set of instructions, when executed by one or more processors of the first device, may cause the first device to split power of the first device to also perform EH during the EH duration.

Some aspects described herein relate to a non-transitory computer-readable medium that stores a set of instructions for wireless communication by a second device. The set of instructions, when executed by one or more processors of the second device, may cause the second device to transmit a DRX configuration that indicates a DRX on-duration for data communication and an EH configuration that indicates an EH duration during which a first device harvests energy, where the DRX on-duration and the EH duration partially overlap or fully overlap. The set of instructions, when executed by one or more processors of the second device, may cause the second device to perform data communication during the DRX on-duration. The set of instructions, when executed by one or more processors of the second device, may cause the second device to transmit energy during the EH duration.

Some aspects described herein relate to an apparatus for wireless communication. The apparatus may include means for receiving a DRX configuration that indicates a DRX on-duration for data communication and an EH configuration that indicates a reserved EH duration during which the apparatus harvests energy and does not transmit or receive data, where the DRX on-duration and the reserved EH duration are part of a periodic cycle. The apparatus may include means for performing data communication during the DRX on-duration. The apparatus may include means for switching one or more antennas of the apparatus to an EH mode. The apparatus may include means for performing EH during the reserved EH duration.

Some aspects described herein relate to an apparatus for wireless communication. The apparatus may include means for transmitting a DRX configuration that indicates a DRX on-duration for data communication and an EH configuration that indicates a reserved EH duration during which another apparatus harvests energy and does not transmit or receive data, where the DRX on-duration and the reserved EH duration are part of a periodic cycle. The apparatus may include means for performing data communication during the DRX on-duration. The apparatus may include means for transmitting energy to the other apparatus during the reserved EH duration.

Some aspects described herein relate to an apparatus for wireless communication. The apparatus may include means for receiving a DRX configuration that indicates a DRX on-duration for data communication and an EH configuration that indicates an EH duration during which the apparatus harvests energy, where the DRX on-duration and the EH duration partially overlap or fully overlap. The apparatus may include means for performing data communication during the DRX on-duration. The apparatus may include means for splitting power of the apparatus to also perform EH during the EH duration.

Some aspects described herein relate to an apparatus for wireless communication. The apparatus may include means for transmitting a DRX configuration that indicates a DRX on-duration for data communication and an EH configuration that indicates an EH duration during which another apparatus harvests energy, where the DRX on-duration and the EH duration partially overlap or fully overlap. The apparatus may include means for performing data communication during the DRX on-duration. The apparatus may include means for transmitting energy during the EH duration.

Aspects generally include a method, apparatus, system, computer program product, non-transitory computer-readable medium, user equipment, wireless device, base station, network entity, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network entity in communication with a user equipment (UE) in a wireless network, in accordance with the present disclosure.

FIG. 3 is a diagram illustrating an example of a disaggregated base station, in accordance with the present disclosure.

FIG. 4 is a diagram illustrating an example of energy harvesting, in accordance with the present disclosure.

FIG. 5 is a diagram illustrating an example associated with using a reserved energy harvesting duration to harvest energy, in accordance with the present disclosure.

FIG. 6 is a diagram illustrating an example of energy harvesting (EH) cycles and discontinuous reception (DRX) cycles, in accordance with the present disclosure.

FIG. 7 is a diagram illustrating an example of EH requests, in accordance with the present disclosure.

FIG. 8 is a diagram illustrating an example of an EH duration that overlaps with a DRX on-duration, in accordance with the present disclosure.

FIG. 9 is a diagram illustrating an example process performed, for example, by a first device, in accordance with the present disclosure.

FIG. 10 is a diagram illustrating an example process performed, for example, by a second device, in accordance with the present disclosure.

FIG. 11 is a diagram illustrating an example process performed, for example, by a first device, in accordance with the present disclosure.

FIG. 12 is a diagram illustrating an example process performed, for example, by a second device, in accordance with the present disclosure.

FIGS. 13-14 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

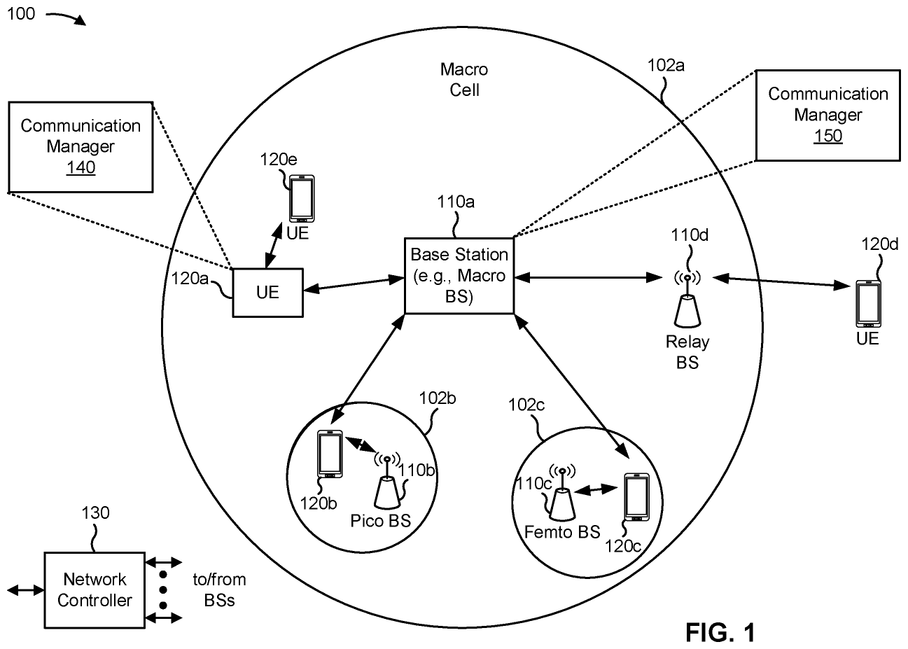

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include a user equipment (UE) 120 or multiple UEs 120 (shown as a UE 120a, a UE 120b, a UE 120c, a UE 120d, and a UE 120e). The wireless network 100 may also include one or more network entities, such as base stations 110 (shown as a BS 110a, a BS 110b, a BS 110c, and a BS 110d), and/or other network entities. A base station 110 is a network entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network entities in the wireless network 100 through various types of backhaul interfaces, such as a direct physical connection or a virtual network, using any suitable transport network.

In some aspects, the term “base station” (e.g., the base station 110) or “network entity” may refer to an aggregated base station, a disaggregated base station, an integrated access and backhaul (IAB) node, a relay node, and/or one or more components thereof. For example, in some aspects, “base station” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station” or “network entity” may refer to one device configured to perform one or more functions, such as those described herein in connection with the base station 110. In some aspects, the term “base station” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station” or “network entity” may refer to any one or more of those different devices. In some aspects, the term “base station” or “network entity” may refer to one or more virtual base stations and/or one or more virtual base station functions. For example, in some aspects, two or more base station functions may be instantiated on a single device. In some aspects, the term “base station” or “network entity” may refer to one of the base station functions and not another. In this way, a single device may include more than one base station.

The wireless network 100 may include one or more relay stations. A relay station is a network entity that can receive a transmission of data from an upstream station (e.g., a network entity or a UE 120) and send a transmission of the data to a downstream station (e.g., a UE 120 or a network entity). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network with network entities that include different types of BSs, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set network entities and may provide coordination and control for these network entities. The network controller 130 may communicate with the base stations 110 via a backhaul communication link. The network entities may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network entity, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network entity as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a first device (e.g., an IoT device, a zero power device, a UE 120, an energy harvesting (EH) device) may include a communication manager 140. As described in more detail elsewhere herein, the communication manager 140 may receive a discontinuous reception (DRX) configuration that indicates a DRX on-duration for data communication and an EH configuration that indicates a reserved EH duration during which the first device harvests energy and does not transmit or receive data, where the DRX on-duration and the reserved EH duration are part of a periodic cycle. The communication manager 140 may perform data communication during the DRX on-duration. The communication manager 140 may switch one or more antennas of the first device to an EH mode and perform EH during the reserved EH duration.

In some aspects, a second device (e.g., a UE 120, a charging device, a base station 110, a network entity) may include a communication manager 150. As described in more detail elsewhere herein, the communication manager 150 may transmit a DRX configuration that indicates a DRX on-duration for data communication and an EH configuration that indicates a reserved EH duration during which a first device harvests energy and does not transmit or receive data, where the DRX on-duration and the reserved EH duration are part of a periodic cycle. The communication manager 150 may perform data communication during the DRX on-duration and transmit energy to the first device during the reserved EH duration.

In some aspects, the communication manager 140 may receive a DRX configuration that indicates a DRX on-duration for data communication and an EH configuration that indicates an EH duration during which the first device harvests energy, where the DRX on-duration and the EH duration partially overlap or fully overlap. The communication manager 140 may perform data communication during the DRX on-duration and split power of the first device to also perform EH during the EH duration. Additionally, or alternatively, the communication manager 140 may perform one or more other operations described herein.

In some aspects, the communication manager 150 may transmit a DRX configuration that indicates a DRX on-duration for data communication and an EH configuration that indicates an EH duration during which a first device harvests energy, where the DRX on-duration and the EH duration partially overlap or fully overlap. The communication manager 150 may perform data communication during the DRX on-duration and transmit energy during the EH duration. Additionally, or alternatively, the communication manager 150 may perform one or more other operations described herein.

As indicated above, FIG. 1 is provided as an example. Other examples may differ from what is described with regard to FIG. 1.

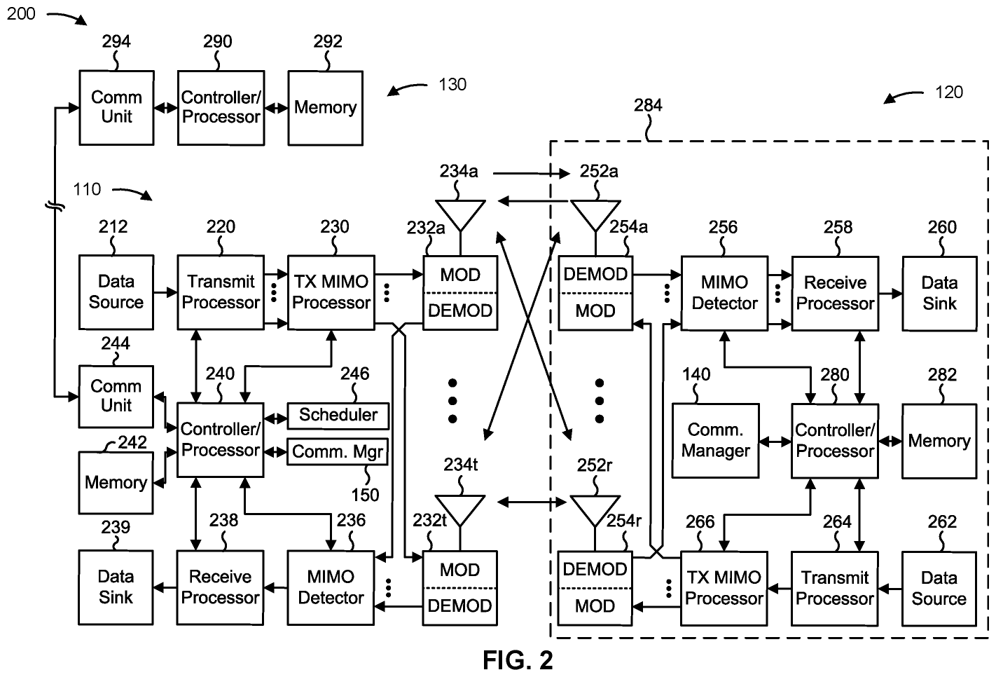

FIG. 2 is a diagram illustrating an example 200 of a network entity (e.g., base station 110) in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network entity via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

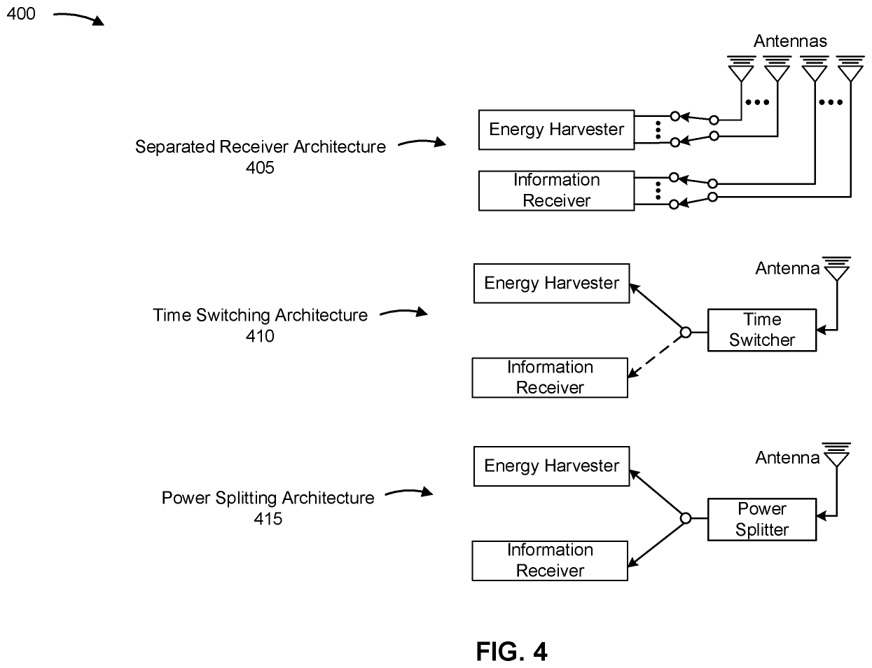

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network entity. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-14).

At the network entity (e.g., base station 110), the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network entity may include a communication unit 244 and may communicate with the network controller 130 via the communication unit 244. The network entity may include a scheduler 246 to schedule one or more UEs 120 for downlink and/or uplink communications. In some examples, the modem 232 of the network entity may include a modulator and a demodulator. In some examples, the network entity includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-14).

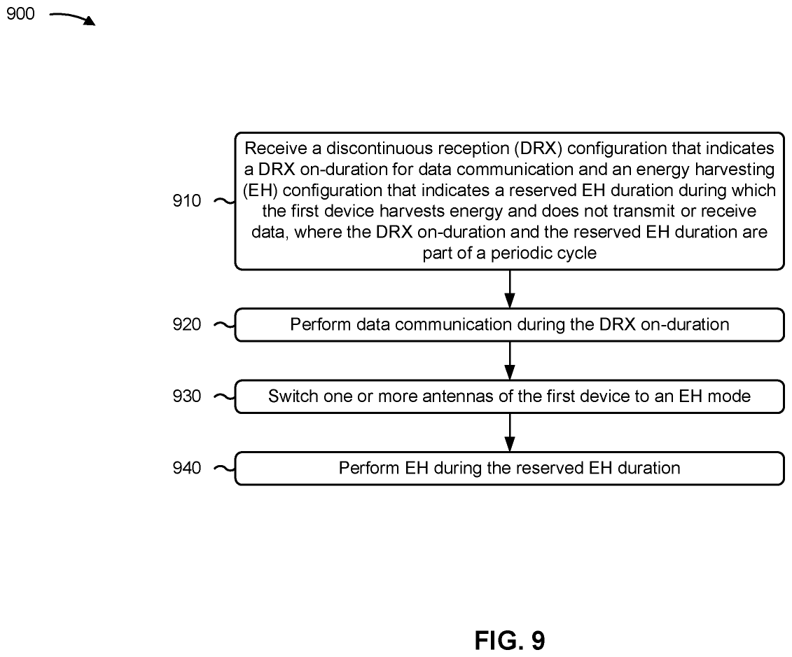

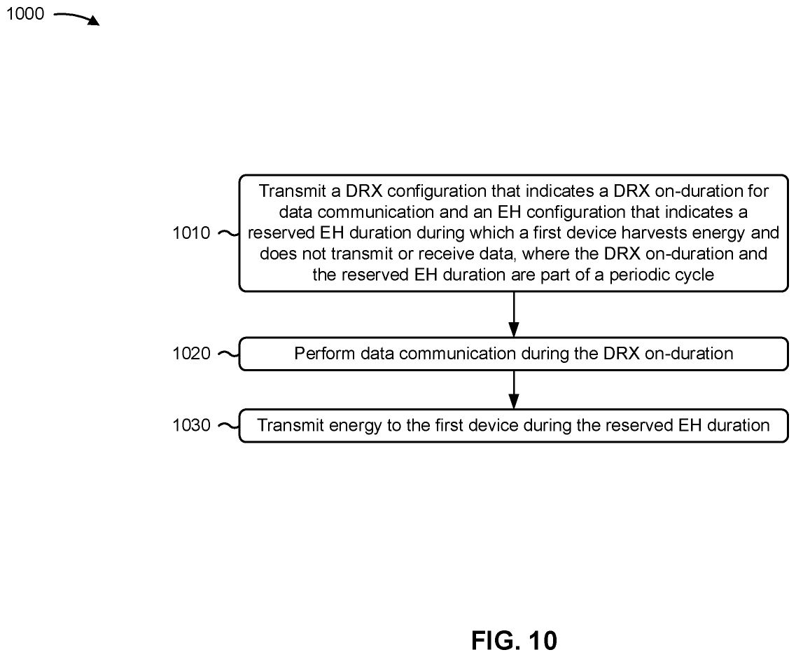

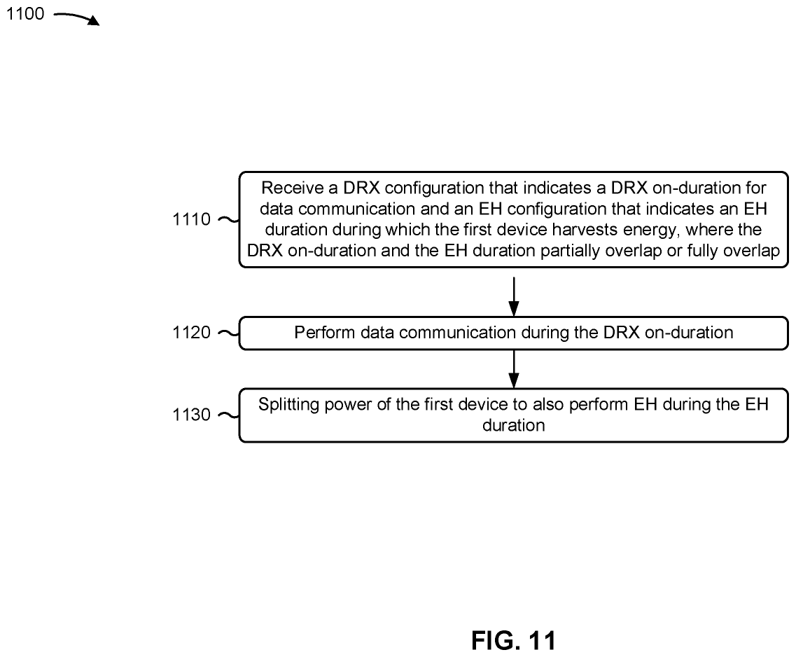

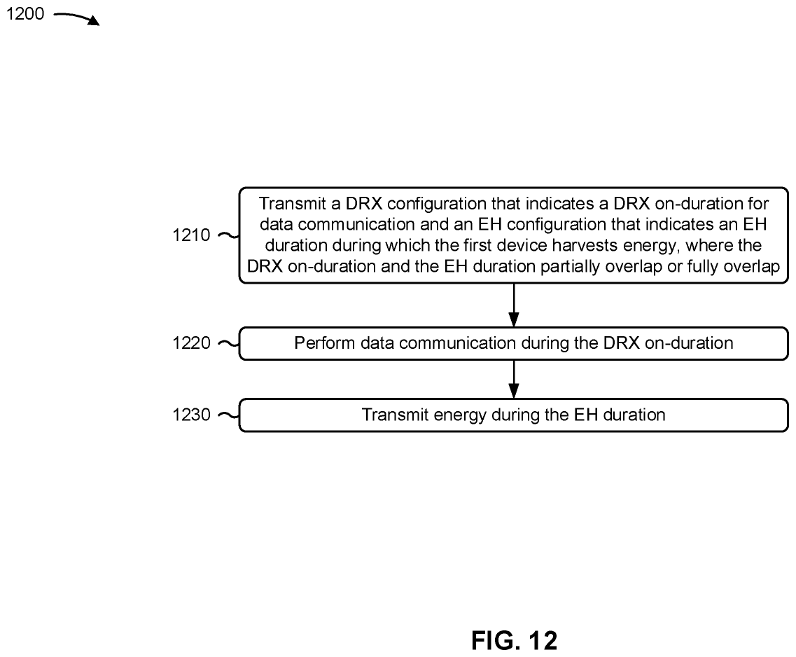

A controller/processor of a network entity, (e.g., the controller/processor 240 of the base station 110), the controller/processor 280 of the UE 120, and/or any other component(s) of FIG. 2 may perform one or more techniques associated with using a specified EH duration for EH, as described in more detail elsewhere herein. In some aspects, the first device described herein is the UE 120, is included in the UE 120, or includes one or more components of the UE 120 shown in FIG. 2. In some aspects, the second device described herein is the UE 120 or the network entity, is included in the UE 120 or the network entity, or includes one or more components of the UE 120 or the base station 110 shown in FIG. 2. For example, the controller/processor 240 of the base station 110, the controller/processor 280 of the UE 120, and/or any other component(s) of FIG. 2 may perform or direct operations of, for example, process 900 of FIG. 9, process 1000 of FIG. 10, process 1100 of FIG. 11, process 1200 of FIG. 12, and/or other processes as described herein. The memory 242 and the memory 282 may store data and program codes for the network entity and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network entity and/or the UE 120, may cause the one or more processors, the UE 120, and/or the network entity to perform or direct operations of, for example, process 900 of FIG. 9, process 1000 of FIG. 10, process 1100 of FIG. 11, process 1200 of FIG. 12, and/or other processes as described herein. In some examples, executing instructions may include running the instructions, converting the instructions, compiling the instructions, and/or interpreting the instructions, among other examples.

In some aspects, a first device (e.g., an IoT device, a zero power device, a UE 120, an EH device) includes means for receiving a DRX configuration that indicates a DRX on-duration for data communication and an EH configuration that indicates a reserved EH duration during which the first device harvests energy and does not transmit or receive data, wherein the DRX on-duration and the reserved EH duration are part of a periodic cycle; means for performing data communication during the DRX on-duration; means for switching one or more antennas of the first device to an EH mode; and/or means for performing EH during the reserved EH duration. In some aspects, the means for the first device to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a second device (e.g., a UE 120, a charging device, base station 110, a network entity) includes means for transmitting a DRX configuration that indicates a DRX on-duration for data communication and an EH configuration that indicates a reserved EH duration during which a first device harvests energy and does not transmit or receive data, where the DRX on-duration and the reserved EH duration are part of a periodic cycle; means for performing data communication during the DRX on-duration; and/or means for transmitting energy to the first device during the reserved EH duration. In some aspects, the means for the second device to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246. In some aspects, the means for the second device to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the first device includes means for receiving a DRX configuration that indicates a DRX on-duration for data communication and an EH configuration that indicates an EH duration during which the first device harvests energy, where the DRX on-duration and the EH duration partially overlap or fully overlap; means for performing data communication during the DRX on-duration; and/or splitting power of the first device to also perform EH during the EH duration.

In some aspects, the second device includes means for transmitting a DRX configuration that indicates a DRX on-duration for data communication and an EH configuration that indicates an EH duration during which a first device harvests energy, where the DRX on-duration and the EH duration partially overlap or fully overlap; means for performing data communication during the DRX on-duration; and/or means for transmitting energy during the EH duration.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

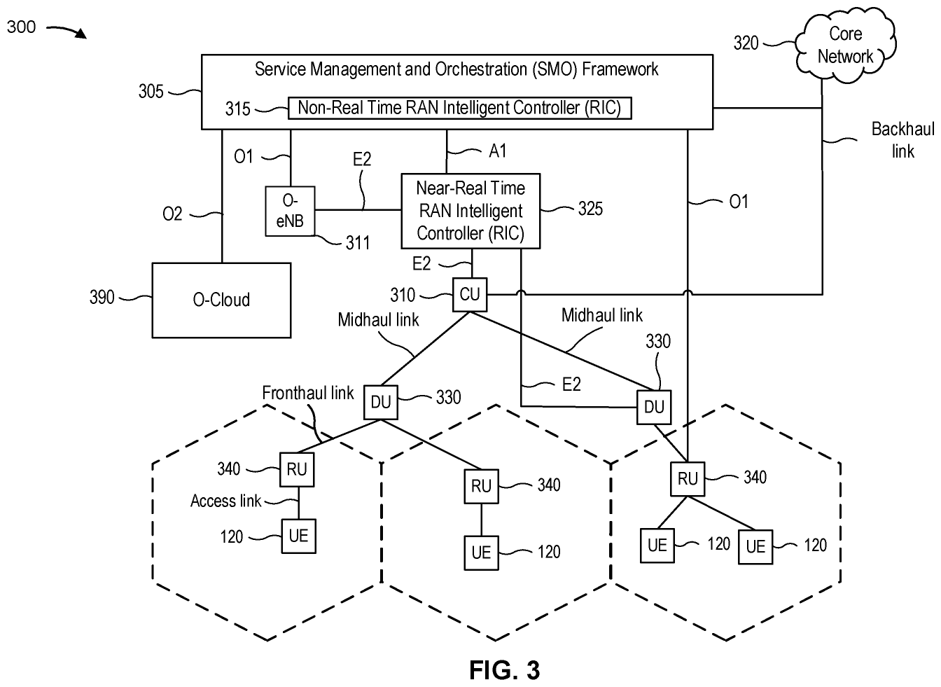

FIG. 3 is a diagram illustrating an example of a disaggregated base station 300, in accordance with the present disclosure.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)).

Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station 300 architecture may include one or more CUs 310 that can communicate directly with a core network 320 via a backhaul link, or indirectly with the core network 320 through one or more disaggregated base station units (such as a Near-Real Time (Near-RT) RIC 325 via an E2 link, or a Non-Real Time (Non-RT) RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The fronthaul link, the midhaul link, and the backhaul link may be generally referred to as “communication links.” The RUs 340 may communicate with respective UEs 120 via one or more radio frequency (RF) access links. In some aspects, the UE 120 may be simultaneously served by multiple RUs 340. The DUs 330 and the RUs 340 may also be referred to as “O-RAN DUs (O-DUs”) and “O-RAN RUs (O-RUs)”, respectively. A network entity may include a CU, a DU, an RU, or any combination of CUs, DUs, and RUs. A network entity may include a disaggregated base station or one or more components of the disaggregated base station, such as a CU, a DU, an RU, or any combination of CUs, DUs, and RUs. A network entity may also include one or more of a TRP, a relay station, a passive device, an intelligent reflective surface (IRS), or other components that may provide a network interface for or serve a UE, mobile station, sensor/actuator, or other wireless device.

Each of the units, i.e., the CUs 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via 01) or via creation of RAN management policies (such as A1 policies).

As indicated above, FIG. 3 is provided as an example. Other examples may differ from what is described with regard to FIG. 3.

FIG. 4 is a diagram illustrating an example 400 of energy harvesting, in accordance with the present disclosure.

Energy harvesting includes a device obtaining energy from a source other than an on-device battery. This may include obtaining energy from a source outside of the device. Devices that use energy harvesting may have a small energy storage device or battery (e.g., smart watch, RedCap devices, eRedCap devices) or no energy storage device or battery (e.g., zero-power devices, IoT devices, wearables, or financial devices). Energy harvesting may include converting RF energy transferred from another device. The harvesting of RF energy may not fully charge a battery but may be used for some tasks like data decoding, operating some filters, data reception, data encoding, data reception, and/or data transmission. The energy may be accumulated over time. Energy harvesting may also be a part of self-sustainable networks, where a node in the network can interact in the network through the energy harvested in the network through transmissions.

As shown in FIG. 4, an RF receiver (e.g., a UE 120) may receive signals (e.g., radio signals carried on radio waves) from an RF transmitter (e.g., a base station 110 or UE 120) and convert electromagnetic energy of the signals (e.g., using a rectenna comprising a dipole antenna with an RF diode) into direct current electricity for use by the RF receiver. The RF receiver may be a low-power device or a zero-power device. The RF transmitter may be referred to as a “charging device.”

As shown by reference number 405, in some aspects, the RF receiver may use a separated receiver architecture, where a first set of antennas is configured to harvest energy, and a second set of antennas is configured to receive data. In this scenario, each set of antennas may be separately configured to receive signals at certain times, frequencies, and/or via one or more particular beams, such that all signals received by the first set of antennas are harvested for energy, and all signals received by the second set of antennas are processed to receive information.

As shown by reference number 410, in some aspects, the RF receiver may use a time-switching architecture to harvest energy. The time switching architecture may use one or more antennas to receive signals, and whether the signals are harvested for energy or processed to receive information depends on the time at which the signals are received. For example, one or more first time slots may be time slots during which received signals are sent to one or more energy harvesting components to harvest energy, and one or more second time slots may be time slots during which received signals are processed and decoded to receive information. In some aspects, the time slots may be pre-configured (e.g., by the RF receiver, the RF transmitter, or another device).

As shown by reference number 415, in some aspects, the RF receiver may use a power splitting architecture to harvest energy. The power splitting architecture may use one or more antennas to receive signals, and the signals are handled by one or both of the energy harvesting and/or information receiving components according to an energy harvesting rate. For example, the RF receiver may be configured to use a first portion of received signals for energy harvesting and the remaining received signals for information receiving. The energy harvesting mode for a device may be semi-statistically configured by RRC messaging. In some aspects, the energy harvesting rate may be pre-configured (e.g., by the RF receiver, the RF transmitter, or another device). Communications with a network entity may be required, even in the energy harvesting mode, but with a reduced radio capability to reduce power consumption.

The RF receiver may receive signals for energy harvesting on certain resources (e.g., time, frequency, and/or spatial resources) and at a certain power level that results in a particular charging rate. Energy harvested by the RF receiver may be used and/or stored for later use. For example, in some aspects, the RF receiver may be powered directly by the harvested energy. In some aspects, the RF receiver may use an energy storage device, such as a battery, capacitor, and/or supercapacitor, to gather and store harvested energy for immediate and/or later use.

The energy harvesting device may have a low-power or wake-up radio that is configured to detect a low-power wake up signal (WUS) but not perform other communications. The energy harvesting device may have a main radio that is configured to perform communications and that consumes more power than the low-power radio or wake-up radio. The energy harvesting device may have limited RF capabilities (less than enhanced UE) or full RF capabilities (comparable to enhanced UE).

Energy harvesting devices, more generally, may rely equally or differently on different energy harvesting techniques such as solar power, vibration, thermal energy, or RF energy harvesting. Energy harvesting can be predictable or unpredictable due to the energy being intermittently available. Current communications use fixed activity cycles for transmission and reception, such as an on duration of an active DRX cycle. The active DRX cycle may include a part of the DRX cycle when a DRX on-duration timer (time UE is monitoring for physical downlink control channel (PDCCH) communications) or a DRX inactivity timer (time UE is active after successfully decoding a PDCCH communication) is running. A timer may run once it is started, until it is stopped or until it expires; otherwise it is not running. A timer may start if it is not running or restarted if it is running. A timer may be started or restarted from its initial value.

If the energy harvesting device does not have sufficient time to charge between DRX on-durations, some communications may be lost when the energy harvesting device does not have enough energy to sustain continuous transmission and reception during a full activity cycle. Continuous transmission and reception may refer to transmission, reception, or both transmission and reception. Sometimes other activities that take place during the OFF period may disrupt charging of the energy harvesting device.

As indicated above, FIG. 4 is provided as an example. Other examples may differ from what is described with regard to FIG. 4.

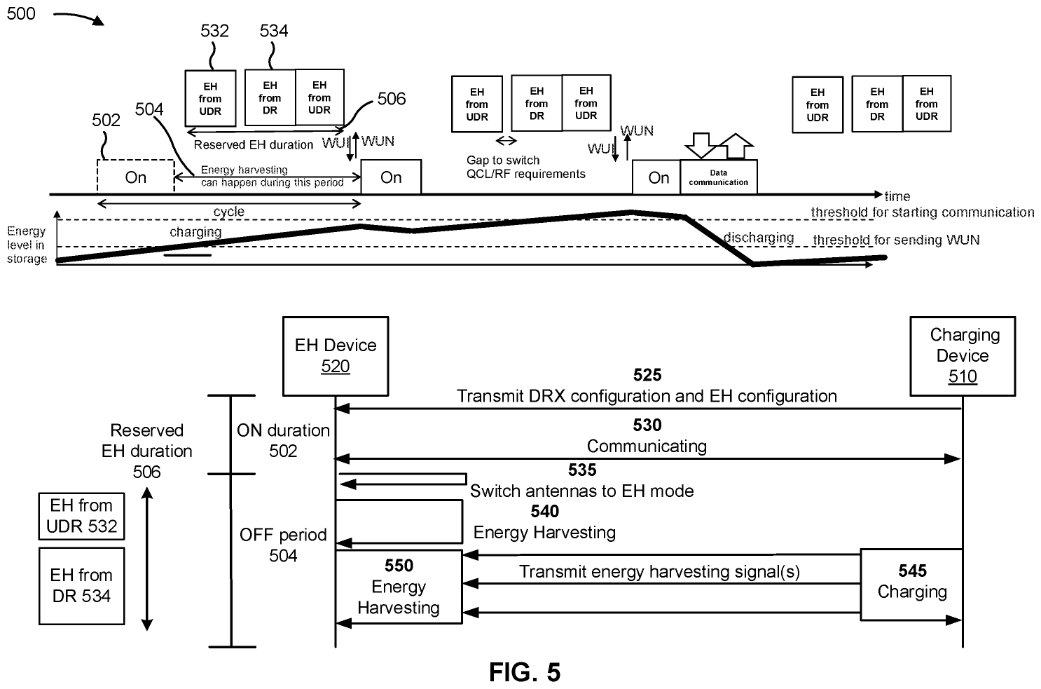

FIG. 5 is a diagram illustrating an example 500 associated with using a reserved EH duration to harvest energy, in accordance with the present disclosure. As shown in FIG. 5, a charging device 510 (e.g., UE 120, a network entity) may transmit RF energy to an EH device 520 (e.g., an IoT device, a zero power device, a UE 120) for EH.

According to various aspects described herein, an EH device that uses a time-switching architecture for EH may perform EH during a reserved EH duration in which the EH device does not transmit or receive data. The reserved EH duration may reserve a time duration or time resources that do not overlap with a DRX on-duration. The DRX configuration may be restricted from interrupting the reserves EH duration. The DRX on-duration and the reserved EH duration may be part of a periodic cycle.

Example 500 shows a DRX on-duration 502 and a DRX OFF period 504 that may be part of a DRX cycle that repeats periodically. The DRX OFF period 504 may include a reserved EH duration 506.

As shown by reference number 525, the charging device 510 or a network entity may transmit a DRX configuration and an EH configuration. The DRX configuration may indicate the on-duration 502 and the EH configuration may indicate the reserved EH duration 506. As shown by reference number 530, the charging device 510 and the EH device 520 may communicate (e.g., transmit and/or receive) data or control information during the on-duration 502. As part of the DRX configuration, the EH device 520 may enter the DRX OFF period 504.

The EH device 520 may prepare to harvest energy during the reserved EH duration 506. In some aspects, the reserved EH duration 506 may include specified or scheduled time resources for EH. This may include one or more dedicated resources (DRs) and/or one or more undedicated resources (UDRs). A DR may include a time resource (e.g., time duration) during which the EH device 520 harvests energy from an expected or scheduled resource, which may be a reliable resource. For example, during the DR, the EH device 520 may reliably harvest RF energy from the charging device 510. The EH device 520 may harvest energy for a DR from RF signals beamformed towards the EH device 520.

A UDR may include a time resource during which the EH device 520 may determine to harvest energy from the charging device 510, harvest energy from another RF energy source or from any RF signals, harvest energy from another non-RF energy source (e.g., solar, vibration, thermal), or not harvest energy at all. The EH device 520 may select one of these options based at least in part on data in a buffer, traffic conditions, channel conditions, and/or an energy harvesting state. An energy harvesting state may be based at least in part on one or more of an amount of the intermittently available energy that is being harvested or an amount of harvested energy that is being stored at the EH device 520. Because the on-duration 502 cannot impede on the reserved EH duration 506 (or especially a DR), the EH device 520 may have enough time to harvest the energy that is necessary to perform communications and other operations.

As shown by reference number 535, the EH device 520 may switch one or more antennas of the EH device 520 to an EH mode. As shown by reference number 540, the EH device 520 may harvest energy during a UDR 532. This may include harvesting energy from a non-RF energy source. For EH during a DR 534, the EH device 520 may set a beam for receive antennas in a direction of the charging device 510. There may be a gap between the UDR 532 and the DR 534 if the EH device 520 is to retune antennas towards the charging device 510. The EH device 520 may be in an EH mode during which the EH device 520 can reliably harvest energy from RF signals. As shown by reference number 545, as part of charging the EH device 520, the charging device 510 may transmit signals to the EH device 520. As shown by reference number 550, the EH device 520 may harvest the energy from the signals and store the energy in an energy storage device (e.g., battery). The EH device 520 may be in a sleep state during EH.

After the reserved EH duration 506, the EH device 520 may receive a wake up indicator (WUI), such as a low-power WUS, and transmit a wake up notification (WUN), which may be an acknowledgement (ACK). The EH device 520 may enter the next DRX cycle and monitor for downlink communications in the next DRX on-duration.

If the EH device 520 is a partially or fully charged device, the activity of the EH device 520 (i.e., harvesting cycle during the DRX off cycle) may be indicated to the charging device 510 and/or the network entity that is serving the EH device 520. That is, the charging device 510 and/or the network entity may have information about the reserved EH duration 506 during the DRX OFF period such that the DRX cycle and DRX on-durations are configured properly. The DRX cycle includes an inactivity timer that extends device activity past a DRX on-duration. The charging device 510 and/or the network entity may adjust the inactivity timer to avoid interrupting the reserved EH duration 506. For example, the EH device 520 may end the inactivity timer before the reserved EH duration 506. The EH device 520 may not expect to receive data during the reserved EH duration 506 and may turn the data chain off and allocate antennas to an EH circuit.

In some aspects, the EH device 520 may transmit an indication of a suggested maximum length of a DRX on-duration after which the network entity cannot extend the DRX on-duration. The EH device 520 may transmit an indication of a suggested time gap between the end of an DRX on-duration and a start of a resource within the reserved EH duration 506. The DRX configuration and the EH configuration may conform to the suggested maximum length of a DRX on-duration and the suggested time gap. The DRX configuration and/or the EH configuration may be included in or may be updated by a WUN.

In some aspects, the network entity or the charging device 510 may dedicate some EH resources to the EH device 520 for EH, the network entity or the charging device 510 may set a DRX cycle (or simply a periodic cycle) and/or an EH cycle (e.g., including a reserved EH duration) using WUNs and WUIs. In some aspects, the WUI and the WUN for a DRX configuration may use different signaling resources than the WUI and the WUN used for a EH configuration. The network entity or the charging device 510 may also use a bit to activate the DR 534. For example, a WUI may indicate a “0” to turn off the DR 534 and a “1” to turn on the DR 534. In some aspects, the network entity or the charging device 510 may use Layer 1 (L1), Layer 2 (L2), or Layer 3 (L3) signaling to change the configuration of a DRX cycle and/or the configuration of an EH cycle based at least in part on user-assistance information or a physical uplink channel feedback indication by the EH device 520. The EH device 520 may transmit an additional energy request to extend the EH cycle or a duration of the DR 534 based at least in part on a last request transmitted by the EH device 520 within a DRX on-duration.

In some aspects, the network entity or the charging device 510 may transmit an indication, in an EH WUI, of an EH cycle duration and/or a reserved EH duration. The network entity or the charging device 510 may also transmit, in an EH WUI, quasi-co-location (QCL) Type D information to be used by the EH device 520 to receive energy during a DR. This may be applicable when there are multiple TRPs, RF source nodes, energy emitters, panels at the network entity or the charging device 510, and/or multiple panels at the EH device 520. The network entity or the charging device 510 may also transmit, in an EH WUI, an indication of an extended duration for a DR, which may be based at least in part on a request from the EH device 520.

As indicated above, FIG. 5 is provided as an example. Other examples may differ from what is described with respect to FIG. 5.

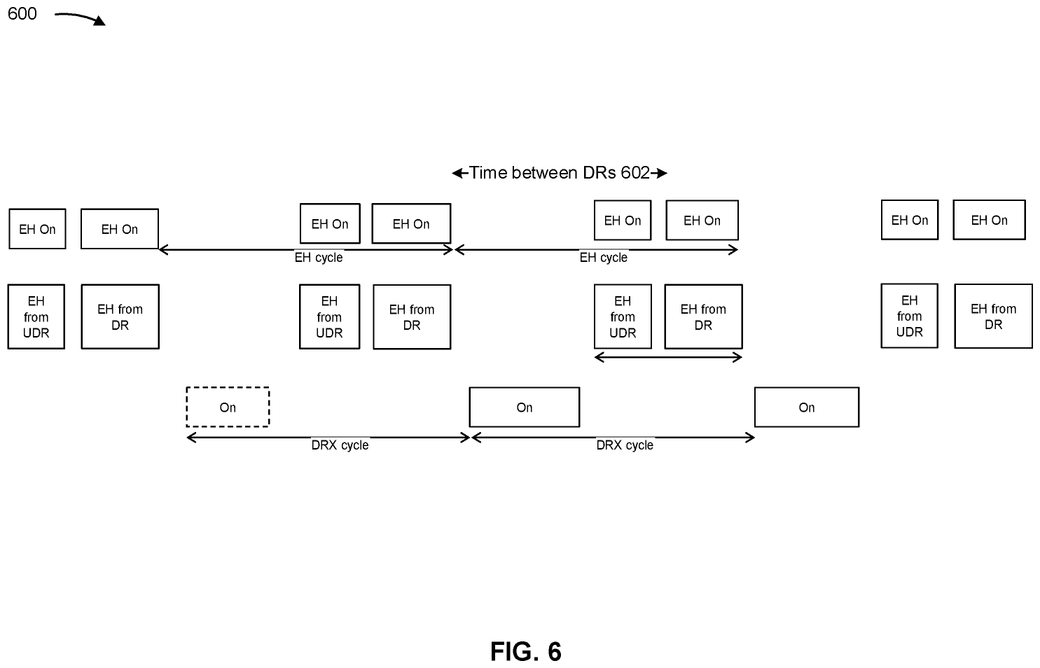

FIG. 6 is a diagram illustrating an example 600 of EH cycles and DRX cycles, in accordance with the present disclosure.

Example 600 shows DRX cycles, configured by a DRX configuration, and EH cycles, configured by an EH configuration. The EH cycle may include one or more UDRs and one or more DRs. In some aspects, the EH device 520 may transmit an indication of a periodicity of the EH cycles, or a length of an EH cycle. The EH device 520 may also transmit an indication of a time between DRs 602, or a periodicity that is specific to DRs.

As indicated above, FIG. 6 is provided as an example. Other examples may differ from what is described with regard to FIG. 6.

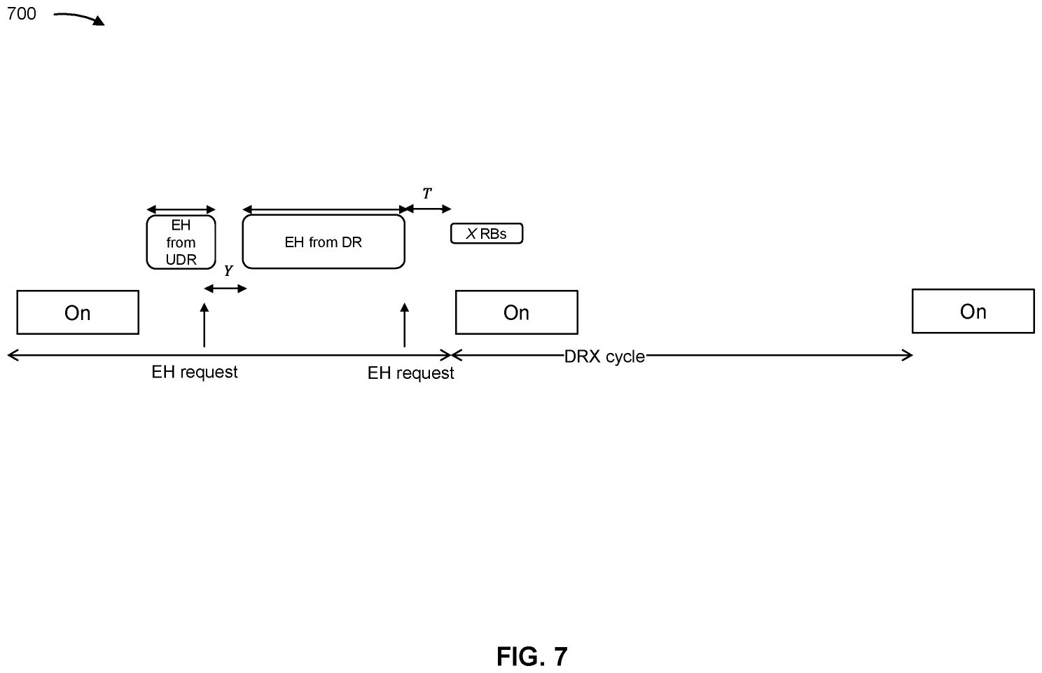

FIG. 7 is a diagram illustrating an example 700 of EH requests, in accordance with the present disclosure.

UDRs and DRs may be activated by the EH device 520, the charging device 510, and/or the network entity. In some aspects, not all DRs may be used for EH unless requested by the EH device 520. The EH device 520 may transmit a request for one or more DRs a time T or T symbols prior to a DRX on-duration or a time Y or Y symbols prior to a DR. The request may include a target power per resource element (RE) or resource block (RB) or a required charging rate to achieve a goal or target power for a next data transmission or data reception. A resource (e.g., UDR) may be specified for a particular quantity X of RBs. The request may include a request of a specified amount of energy per data volume or per message. The request may include, in association with one or more DRs, one or more component carriers, bandwidth parts (BWPs), or frequency band/BWP combinations to be used to transmit energy to the UE. If there are multiple devices (e.g., network entity, RF power sources or emitters, UEs), the request may include suggested devices or users to which energy may be transmitted.

If the request was sent a time T or T symbols before the next on-duration, the network entity may configure or preconfigure configured grants during the on-duration for EH during the reserved EH duration 506. Alternatively, the network entity may activate the next DRs for EH or the next set of Z resources across Z reserved EH durations (or during DRX OFF periods, more generally). The network entity may perform a combination of the providing of configured grants and the activating of DRs for EH. The request may be a standalone request or a request that is multiplexed with a WUN.

In some aspects, the EH device 520 may have a different set of RF EH cycles and EH configurations based on a EH type that is being used. A particular EH type may be used for a set of EH classes (defined in a specification or determined based on a configuration). A set of EH classes may be based at least in part on a hardware or circuit designed and an energy harvesting or energy harvesting conversion efficiency. If the EH device 520 can be a data full-duplex/half-duplex device, the configuration may be parameterized based at least in part on whether the device is a half-duplex device or a full-duplex device.

In some aspects, the EH cycle may change based at least in part on the how many devices are nearby and how clear the channels are in a frequency range or for a beamforming gain. Accordingly, there may be updates to the EH cycle, whether periodically or aperiodically. The updates may include suggestions from the EH device 520 and/or configurations from the network entity or the charging device 510. In some aspects, the EH device 520 may select a suggested configuration from among multiple configurations, and the network entity may select the suggested configuration.

As indicated above, FIG. 7 is provided as an example. Other examples may differ from what is described with regard to FIG. 7.

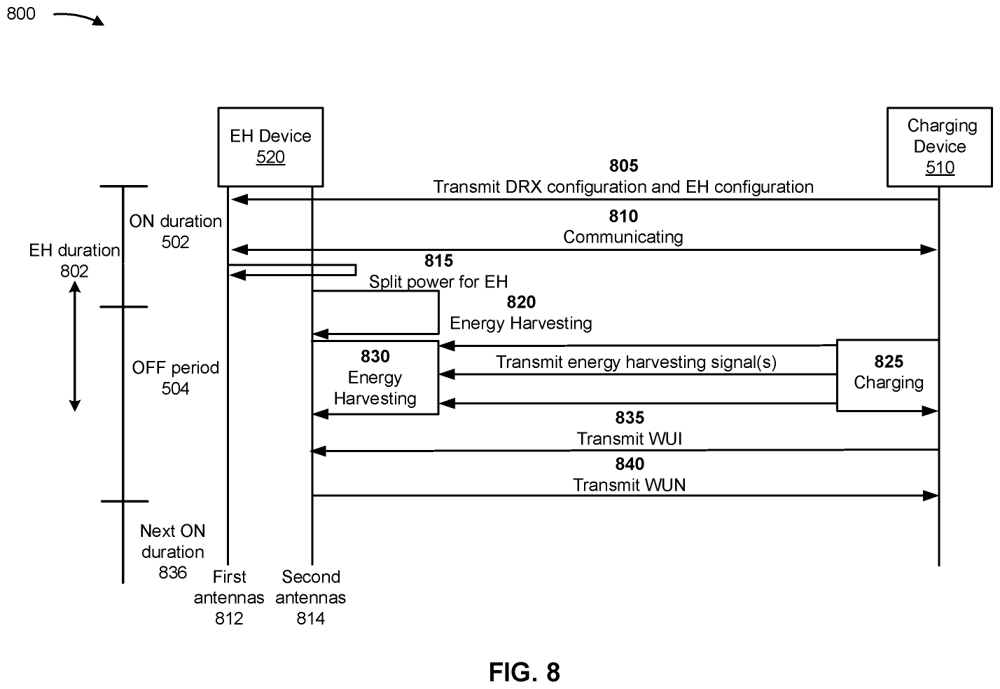

FIG. 8 is a diagram illustrating an example 800 of an EH duration that overlaps with a DRX on-duration, in accordance with the present disclosure.

While example 500 in FIG. 5 involves a reserved EH duration that does not overlap with a DRX on-duration, in some scenarios, the EH duration may not be reserved and may overlap fully or partially with a DRX on-duration. Example 800 shows that an EH duration 802 may overlap with a DRX on-duration 502. This may be possible if the EH device 520 is configured with a power-splitting architecture for EH. In example 500 of FIG. 5, the EH device 520 may be configured with a time-switching architecture rather than a power-splitting architecture. Accordingly, in some aspects, the EH device 520 may perform data communications during the on-duration 502 and split power to also perform EH during the on-duration 502. The charging device 510 may transmit RF energy during the on-duration 502.

Example 800 shows EH during the on-duration 502. As shown by reference number 805, the charging device 510 (or a network entity) may transmit a DRX configuration and an EH configuration. As shown by reference number 810, the EH device 520 may communicate during the on-duration 502. As shown by reference number 815, while in the on-duration 502, the EH device 520 may split power for EH. The EH device 520 may have one or more first antennas 812 and one or more second antennas 814. Splitting power for EH may include switching one or more antennas (e.g., second antennas 814) to an EH mode or an EH circuit while maintaining one or more antennas (e.g., first antennas 812) for data communication. This may start the EH duration 802.

As shown by reference number 820, the EH device 520 may start EH using, for example, a UDR. The EH device 520 may transition to using a DR. As shown by reference number 825, the charging device 510 may transmit energy to charge the EH device 520. As shown by reference number 830, the EH device 520 may harvest energy.

As shown by reference number 835, the charging device 510 may transmit a WUI to wake up the EH device 520 from the OFF period 504 and to monitor for communications in the next on-duration 836. As shown by reference number 840, the EH device 520 may transmit a WUN. The WUN may include a suggested length for the EH duration 802 in the next EH cycle.

The WUN may also include a suggested power splitting factor to be used if the EH device 520 is to be splitting power between data communications and EH during the next on-duration 836. The power splitting factor may specify what portion of the antennas or power is to be used for data communications and what portion of the antennas or power is to be used for EH. The power splitting factor may be a ratio. For example, the power splitting factor may be a ratio value of 0, 1, or in between 0 and 1. The ratio value of 0 may correspond to all EH and no data reception/transmission, and the ratio value of 1 may correspond to all data reception/transmission and no EH (or vice versa). Using a ratio value of 0 and 1 may be similar to a time-switching architecture.

The EH device 520 may indicate a set of power splitting factors for each type of physical channel, such as for a physical downlink control channel (PDCCH), a physical downlink shared channel (PDSCH), and/or a physical sidelink shared channel (PSCCH). If the EH device 520 is a full duplex device, the EH device 520 may also indicate power splitting factors for a physical uplink control channel (PUCCH) or a physical uplink shared channel (PUSCH). The EH device 520 may set a power splitting factor whether the EH device 520 is operating in a half duplex mode or a full duplex mode.

Whether the same WUN and WUI control signals are used for both data and EH or different (dedicated) WUN and WUI control signals are used for data and EH, the EH device 520 may indicate in a WUN that the EH device 520 expects the EH duration 802 to be extended by a specified amount in the next EH cycle. In some aspects, the extension of the EH duration 802 may be into a delta time unit gap before the next WUI and WUN. This may be applicable when there should be no overlap between a DRX cycle and an EH cycle. The extension of the EH duration 802 may be beyond the WUI, the WUN, and the next on-duration 836 of the next DRX cycle. The EH duration 802 may be shorted or delayed. The next on-duration 836 may be shortened or delayed.

By providing both a DRX configuration and an EH configuration for overlapping DRX cycles and EH cycles, the EH device 520 may operate with a more efficient use of the antennas. This may improve communications, reduce latency, and conserve power of the EH device 520.

As indicated above, FIG. 8 is provided as an example. Other examples may differ from what is described with regard to FIG. 8.

FIG. 9 is a diagram illustrating an example process 900 performed, for example, by a first device, in accordance with the present disclosure. Example process 900 is an example where the first device (e.g., EH device 520) performs operations associated with using a reserved EH duration.

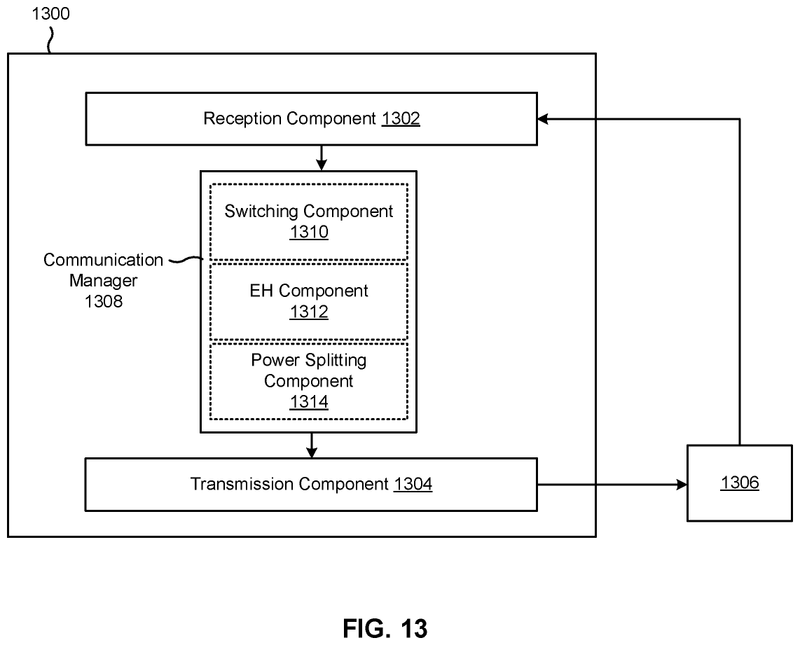

As shown in FIG. 9, in some aspects, process 900 may include receiving a DRX configuration that indicates a DRX on-duration for data communication and an EH configuration that indicates a reserved EH duration during which the first device harvests energy and does not transmit or receive data, where the DRX on-duration and the reserved EH duration are part of a periodic cycle (block 910). For example, the first device (e.g., using communication manager 1308 and/or reception component 1302 depicted in FIG. 13) may receive a DRX configuration that indicates a DRX on-duration for data communication and an EH configuration that indicates a reserved EH duration during which the first device harvests energy and does not transmit or receive data, where the DRX on-duration and the reserved EH duration are part of a periodic cycle, as described above.

As further shown in FIG. 9, in some aspects, process 900 may include performing data communication during the DRX on-duration (block 920). For example, the first device (e.g., using communication manager 1308, transmission component 1304, and/or reception component 1302 depicted in FIG. 13) may perform data communication during the DRX on-duration, as described above.

As further shown in FIG. 9, in some aspects, process 900 may include switching one or more antennas of the first device to an EH mode (block 930). For example, the first device (e.g., using communication manager 1308 and/or switching component 1310 depicted in FIG. 13) may switch one or more antennas of the first device to an EH mode, as described above.

As further shown in FIG. 9, in some aspects, process 900 may include performing EH during the reserved EH duration (block 940). For example, the first device (e.g., using communication manager 1308 and/or EH component 1312, depicted in FIG. 13) may perform EH during the reserved EH duration, as described above.

Process 900 may include additional aspects, such as any single aspect or any combination of aspects described below and/or in connection with one or more other processes described elsewhere herein.

In a first aspect, the reserved EH duration does not overlap with the DRX on-duration.

In a second aspect, alone or in combination with the first aspect, the DRX configuration specifies that an inactivity timer associated with the DRX on-duration ends before the reserved EH duration.

In a third aspect, alone or in combination with one or more of the first and second aspects, process 900 includes receiving an indication of a maximum length for the DRX on-duration, and the DRX configuration specifies that the DRX on-duration cannot exceed the maximum length.

In a fourth aspect, alone or in combination with one or more of the first through third aspects, the EH configuration specifies a dedicated resource (DR) within the reserved EH duration to be used for a dedicated source of energy.

In a fifth aspect, alone or in combination with one or more of the first through fourth aspects, the EH configuration specifies a time between the DR and another DR.

In a sixth aspect, alone or in combination with one or more of the first through fifth aspects, the EH configuration specifies a UDR within the reserved EH duration that is available for using a source of energy other than the dedicated source of energy.

In a seventh aspect, alone or in combination with one or more of the first through sixth aspects, process 900 includes receiving an indication to use the DR in the reserved EH duration.

In an eighth aspect, alone or in combination with one or more of the first through seventh aspects, the indication includes one or more of a target power, a target charging rate, an energy request, or a target device for energy.

In a ninth aspect, alone or in combination with one or more of the first through eighth aspects, the indication includes one or more of a suggested component carrier, a suggested BWP, or a suggested combination of frequency band and BWP.

In a tenth aspect, alone or in combination with one or more of the first through ninth aspects, receiving the indication includes receiving the indication in a wake-up message (e.g., WUI).

In an eleventh aspect, alone or in combination with one or more of the first through tenth aspects, the indication indicates one or more of the reserved EH duration, EH cycle information, quasi-co-location information for EH, or an extended dedicated resource duration.

In a twelfth aspect, alone or in combination with one or more of the first through eleventh aspects, the DRX configuration or the EH configuration specifies a time gap between an end of the DRX on-duration and a start of a resource within the reserved EH duration.

In a thirteenth aspect, alone or in combination with one or more of the first through twelfth aspects, the DRX configuration or the EH configuration specifies that there is to be no active time extension for the DRX on-duration during the reserved EH duration.

In a fourteenth aspect, alone or in combination with one or more of the first through thirteenth aspects, process 900 includes receiving one or more of a configured grant or an indication to activate a dedicated resource in response to transmitting an EH request at least a specified quantity of symbols before another DRX on-duration.

In a fifteenth aspect, alone or in combination with one or more of the first through fourteenth aspects, the EH configuration is based at least in part on a type of the first device.

In a sixteenth aspect, alone or in combination with one or more of the first through fifteenth aspects, process 900 includes receiving an update to the EH configuration that is based at least in part on a quantity of neighboring devices, channel state information, a frequency range, or a beamforming gain.

In a seventeenth aspect, alone or in combination with one or more of the first through sixteenth aspects, process 900 includes transmitting user assistance information, physical channel feedback, or an energy request, and receiving the update includes receiving the update during the DRX on-duration.

In an eighteenth aspect, alone or in combination with one or more of the first through seventeenth aspects, receiving the DRX configuration includes receiving the DRX configuration in a wake-up message.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a second device, in accordance with the present disclosure. Example process 1000 is an example where the second device (e.g., charging device 510, a network entity) performs operations associated with indicating a reserved EH duration.

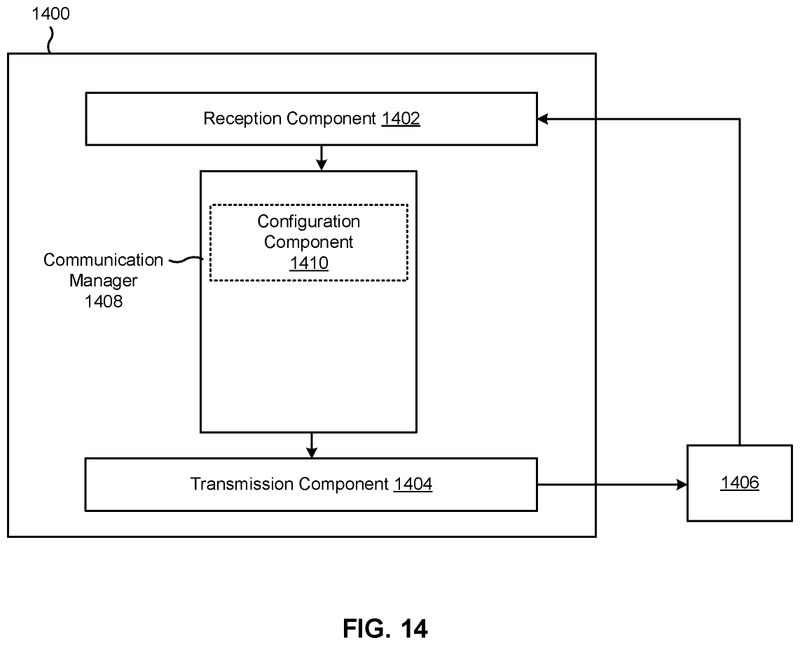

As shown in FIG. 10, in some aspects, process 1000 may include transmitting a DRX configuration that indicates a DRX on-duration for data communication and an EH configuration that indicates a reserved EH duration during which a first device harvests energy and does not transmit or receive data, where the DRX on-duration and the reserved EH duration are part of a periodic cycle (block 1010). For example, the second device (e.g., using communication manager 1408 and/or transmission component 1404 depicted in FIG. 14) may transmit a DRX configuration that indicates a DRX on-duration for data communication and an EH configuration that indicates a reserved EH duration during which a first device harvests energy and does not transmit or receive data, where the DRX on-duration and the reserved EH duration are part of a periodic cycle, as described above.

As further shown in FIG. 10, in some aspects, process 1000 may include performing data communication during the DRX on-duration (block 1020). For example, the second device (e.g., using communication manager 1408, transmission component 1404, and/or reception component 1402 depicted in FIG. 14) may perform data communication during the DRX on-duration, as described above.

As further shown in FIG. 10, in some aspects, process 1000 may include transmitting energy to the first device during the reserved EH duration (block 1030). For example, the second device (e.g., using communication manager 1408 and/or transmission component 1404 depicted in FIG. 14) may transmit energy to the first device during the reserved EH duration, as described above.

Process 1000 may include additional aspects, such as any single aspect or any combination of aspects described below and/or in connection with one or more other processes described elsewhere herein.

In a first aspect, process 1000 includes transmitting an indication of a maximum length for the DRX on-duration, and the DRX configuration specifies that the DRX on-duration cannot exceed the maximum length.

In a second aspect, alone or in combination with the first aspect, process 1000 includes transmitting an indication to use a DR in the reserved EH duration.

In a third aspect, alone or in combination with one or more of the first and second aspects, process 1000 includes transmitting an update to the EH configuration that is based at least in part on one or more of a quantity of neighboring devices, channel state information, a frequency range, or a beamforming gain.

In a fourth aspect, alone or in combination with one or more of the first through third aspects, transmitting the DRX configuration includes transmitting the DRX configuration in a wake-up message.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a first device, in accordance with the present disclosure. Example process 1100 is an example where the first device (e.g., EH device 520) performs operations associated with using an EH duration that can overlap with a DRX on-duration.

As shown in FIG. 11, in some aspects, process 1100 may include receiving a DRX configuration that indicates a DRX on-duration for data communication and an EH configuration that indicates an EH duration during which the first device harvests energy, where the DRX on-duration and the EH duration partially overlap or fully overlap (block 1110). For example, the first device or EH device (e.g., using communication manager 1308 and/or reception component 1302 depicted in FIG. 13) may receive a DRX configuration that indicates a DRX on-duration for data communication and an EH configuration that indicates an EH duration during which the first device harvests energy, where the DRX on-duration and the EH duration partially overlap or fully overlap, as described above.

As further shown in FIG. 11, in some aspects, process 1100 may include performing data communication during the DRX on-duration (block 1120). For example, the first device (e.g., using communication manager 1308, transmission component 1304, and/or reception component 1302 depicted in FIG. 13) may perform data communication during the DRX on-duration, as described above.

As further shown in FIG. 11, in some aspects, process 1100 may include splitting power of the first device to also perform EH during the EH duration (block 1130). For example, the first device (e.g., using communication manager 1308, power splitting component 1314, and/or EH component 1312 depicted in FIG. 13) may split power of the first device to also perform EH during the EH duration, as described above.

Process 1100 may include additional aspects, such as any single aspect or any combination of aspects described below and/or in connection with one or more other processes described elsewhere herein.

In a first aspect, process 1100 includes transmitting an indication of the EH duration in a wake-up message.

In a second aspect, alone or in combination with the first aspect, process 1100 includes transmitting one or more power splitting factors for splitting power between the DRX on-duration and the EH duration.

In a third aspect, alone or in combination with one or more of the first and second aspects, process 1100 includes transmitting an indication of one or more time gaps in association with one or more wake-up messages.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a second device, in accordance with the present disclosure. Example process 1200 is an example where the second device (e.g., charging device 510, a network entity) performs operations associated with indicating an EH duration that can overlap with a DRX on-duration.

As shown in FIG. 12, in some aspects, process 1200 may include transmitting a DRX configuration that indicates a DRX on-duration for data communication and an EH configuration that indicates an EH duration during which the first device harvests energy, where the DRX on-duration and the EH duration partially overlap or fully overlap (block 1210). For example, the second device (e.g., using communication manager 1408 and/or transmission component 1404 depicted in FIG. 14) may transmit a DRX configuration that indicates a DRX on-duration for data communication and an EH configuration that indicates an EH duration during which the first device harvests energy, where the DRX on-duration and the EH duration partially overlap or fully overlap, as described above.

As further shown in FIG. 12, in some aspects, process 1200 may include performing data communication during the DRX on-duration (block 1220). For example, the second device (e.g., using communication manager 1408, transmission component 1404, and/or reception component 1402 depicted in FIG. 14) may perform data communication during the DRX on-duration, as described above.

As further shown in FIG. 12, in some aspects, process 1200 may include transmitting energy during the EH duration (block 1230). For example, the first device or charging device (e.g., using communication manager 1408 and/or transmission component 1404 depicted in FIG. 14) may transmit energy during the EH duration, as described above.

Process 1200 may include additional aspects, such as any single aspect or any combination of aspects described below and/or in connection with one or more other processes described elsewhere herein.

In a first aspect, process 1200 includes transmitting an indication of the EH duration in a wake-up message.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication. The apparatus 1300 may be a first device (e.g., a UE 120, EH device 520), or a first device may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, network entity, charging device, or another wireless communication device) using the reception component 1302 and the transmission component 1304. As further shown, the apparatus 1300 may include the communication manager 1308. The communication manager 1308 may control and/or otherwise manage one or more operations of the reception component 1302 and/or the transmission component 1304. In some aspects, the communication manager 1308 may include one or more antennas, a modem, a controller/processor, a memory, or a combination thereof, of the UE described in connection with FIG. 2. The communication manager 1308 may be, or be similar to, the communication manager 140 depicted in FIGS. 1 and 2. For example, in some aspects, the communication manager 1308 may be configured to perform one or more of the functions described as being performed by the communication manager 140. In some aspects, the communication manager 1308 may include the reception component 1302 and/or the transmission component 1304. The communication manager 1308 may include a switching component 1310, an EH component 1312, and/or a power splitting component 1314, among other examples.

In some aspects, the apparatus 1300 may be configured to perform one or more operations described herein in connection with FIGS. 1-8. Additionally, or alternatively, the apparatus 1300 may be configured to perform one or more processes described herein, such as process 900 of FIG. 9, process 1100 of FIG. 11, or a combination thereof. In some aspects, the apparatus 1300 and/or one or more components shown in FIG. 13 may include one or more components of the first device described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the first device described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the first device described in connection with FIG. 2. In some aspects, the transmission component 1304 may be co-located with the reception component 1302 in a transceiver.

The reception component 1302 may receive a DRX configuration that indicates a DRX on-duration for data communication and an EH configuration that indicates a reserved EH duration during which the first device harvests energy and does not transmit or receive data, where the DRX on-duration and the reserved EH duration are part of a periodic cycle. The transmission component 1304 and the reception component 1302 may perform data communication during the DRX on-duration. The switching component 1310 may switch one or more antennas of the first device to an EH mode. The EH component 1312 may perform EH during the reserved EH duration.

The reception component 1302 may receive an indication of a maximum length for the DRX on-duration, and the DRX configuration specifies that the DRX on-duration cannot exceed the maximum length. The reception component 1302 may receive an indication to use the dedicated resource in the reserved EH duration.

The reception component 1302 may receive one or more of a configured grant or an indication to activate a dedicated resource in response to transmitting an EH request at least a specified quantity of symbols before another DRX on-duration. The reception component 1302 may receive an update to the EH configuration that is based at least in part on a quantity of neighboring devices, channel state information, a frequency range, or a beamforming gain. The transmission component 1304 may transmit user assistance information, physical channel feedback, or an energy request, and wherein receiving the update includes receiving the update during the DRX on-duration.

In some aspects, the reception component 1302 may receive a DRX configuration that indicates a DRX on-duration for data communication and an EH configuration that indicates an EH duration during which the first device harvests energy, wherein the DRX on-duration and the EH duration partially overlap or fully overlap. The transmission component 1304 and the reception component 1302 may perform data communication during the DRX on-duration. The power splitting component 1314 may split power of the first device to also perform EH during the EH duration using the EH component 1312.

The transmission component 1304 may transmit an indication of the EH duration in a wake-up message. The transmission component 1304 may transmit one or more power splitting factors for splitting power between the DRX on-duration and the EH duration. The transmission component 1304 may transmit an indication of one or more time gaps in association with one or more wake-up messages.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication. The apparatus 1400 may be a second device (e.g., a UE 120, a charging device 510, a network entity), or a second device may include the apparatus 1400. In some aspects, the apparatus 1400 includes a reception component 1402 and a transmission component 1404, which may be in communication with one another (for example, via one or more buses and/or one or more other components). As shown, the apparatus 1400 may communicate with another apparatus 1406 (such as a UE, a base station, or another wireless communication device) using the reception component 1402 and the transmission component 1404. As further shown, the apparatus 1400 may include the communication manager 1408. The communication manager 1408 may control and/or otherwise manage one or more operations of the reception component 1402 and/or the transmission component 1404. In some aspects, the communication manager 1408 may include one or more antennas, a modem, a controller/processor, a memory, or a combination thereof, of the UE or the base station described in connection with FIG. 2. The communication manager 1408 may be, or be similar to, the communication manager 150 depicted in FIGS. 1 and 2. For example, in some aspects, the communication manager 1408 may be configured to perform one or more of the functions described as being performed by the communication manager 150. In some aspects, the communication manager 1408 may include the reception component 1302 and/or the transmission component 1404. The communication manager 1408 may include a configuration component 1410, among other examples.

In some aspects, the apparatus 1400 may be configured to perform one or more operations described herein in connection with FIGS. 1-8. Additionally, or alternatively, the apparatus 1400 may be configured to perform one or more processes described herein, such as process 1000 of FIG. 10, process 1200 of FIG. 12, or a combination thereof. In some aspects, the apparatus 1400 and/or one or more components shown in FIG. 14 may include one or more components of the second device described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the second device described in connection with FIG. 2.

The transmission component 1404 may transmit communications, such as reference signals, control information, data communications, or a combination thereof, to the apparatus 1406. In some aspects, one or more other components of the apparatus 1400 may generate communications and may provide the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, a modem, a modulator, a transmit MIMO processor, a transmit processor, a controller/processor, a memory, or a combination thereof, of the second device described in connection with FIG. 2. In some aspects, the transmission component 1404 may be co-located with the reception component 1402 in a transceiver.

The transmission component 1404 may transmit a DRX configuration that indicates a DRX on-duration for data communication and an EH configuration that indicates a reserved EH duration during which a first device harvests energy and does not transmit or receive data, where the DRX on-duration and the reserved EH duration are part of a periodic cycle. The configuration component 1410 may generate the DRX configuration and the EH configuration. The transmission component 1404 and the reception component 1402 may perform data communication during the DRX on-duration. The transmission component 1404 may transmit energy to the first device during the reserved EH duration.

The transmission component 1404 may transmit an indication of a maximum length for the DRX on-duration, and wherein the DRX configuration specifies that the DRX on-duration cannot exceed the maximum length. The transmission component 1404 may transmit an indication to use a dedicated resource in the reserved EH duration. The transmission component 1404 may transmit an update to the EH configuration that is based at least in part on one or more of a quantity of neighboring devices, channel state information, a frequency range, or a beamforming gain.

In some aspects, the transmission component 1404 may transmit a DRX configuration that indicates a DRX on-duration for data communication and an EH configuration that indicates an EH duration during which a first device harvests energy, where the DRX on-duration and the EH duration partially overlap or fully overlap. The configuration component 1410 may generate the DRX configuration and the EH configuration. The transmission component 1404 and the reception component 1402 may perform data communication during the DRX on-duration. The transmission component 1404 may transmit energy during the EH duration. The transmission component 1404 may transmit an indication of the EH duration in a wake-up message.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:
Aspect 1: A method of wireless communication performed by a first device, comprising: receiving a discontinuous reception (DRX) configuration that indicates a DRX on-duration for data communication and an energy harvesting (EH) configuration that indicates a reserved EH duration during which the first device harvests energy and does not transmit or receive data, wherein the DRX on-duration and the reserved EH duration are part of a periodic cycle; performing data communication during the DRX on-duration; switching one or more antennas of the first device to an EH mode; and performing EH during the reserved EH duration.
Aspect 2: The method of Aspect 1, wherein the reserved EH duration does not overlap with the DRX on-duration.
Aspect 3: The method of Aspect 1 or 2, wherein the DRX configuration specifies that an inactivity timer associated with the DRX on-duration ends before the reserved EH duration.
Aspect 4: The method of any of Aspects 1-3, further comprising receiving an indication of a maximum length for the DRX on-duration, and wherein the DRX configuration specifies that the DRX on-duration cannot exceed the maximum length.
Aspect 5: The method of any of Aspects 1-4, wherein the EH configuration specifies a dedicated resource within the reserved EH duration to be used for a dedicated source of energy.
Aspect 6: The method of Aspect 5, wherein the EH configuration specifies a time between the dedicated resource and another dedicated resource.
Aspect 7: The method of Aspect 5 or 6, wherein the EH configuration specifies an undedicated resource within the reserved EH duration that is available for using a source of energy other than the dedicated source of energy.
Aspect 8: The method of any of Aspects 5-7, further comprising receiving an indication to use the dedicated resource in the reserved EH duration.
Aspect 9: The method of Aspect 8, wherein the indication includes one or more of a target power, a target charging rate, an energy request, or a target device for energy.
Aspect 10: The method of Aspect 8 or 9, wherein the indication includes one or more of a suggested component carrier, a suggested bandwidth part (BWP), or a suggested combination of frequency band and BWP.
Aspect 11: The method of any of Aspects 8-10, wherein receiving the indication includes receiving the indication in a wake-up message.
Aspect 12: The method of any of Aspects 8-11, wherein the indication indicates one or more of the reserved EH duration, EH cycle information, quasi-co-location information for EH, or an extended dedicated resource duration.
Aspect 13: The method of Aspect 1, wherein the DRX configuration or the EH configuration specifies a time gap between an end of the DRX on-duration and a start of a resource within the reserved EH duration.
Aspect 14: The method of any of Aspects 1-13, wherein the DRX configuration or the EH configuration specifies that there is to be no active time extension for the DRX on-duration during the reserved EH duration.
Aspect 15: The method of any of Aspects 1-14, further comprising receiving one or more of a configured grant or an indication to activate a dedicated resource in response to transmitting an EH request at least a specified quantity of symbols before another DRX on-duration.
Aspect 16: The method of any of Aspects 1-15, wherein the EH configuration is based at least in part on a type of the first device.
Aspect 17: The method of any of Aspects 1-16, further comprising receiving an update to the EH configuration that is based at least in part on a quantity of neighboring devices, channel state information, a frequency range, or a beamforming gain.
Aspect 18: The method of Aspect 17, further comprising transmitting user assistance information, physical channel feedback, or an energy request, and wherein receiving the update includes receiving the update during the DRX on-duration.
Aspect 19: The method of any of Aspects 1-18, wherein receiving the DRX configuration includes receiving the DRX configuration in a wake-up message.
Aspect 20: A method of wireless communication performed by a second device, comprising: transmitting a discontinuous reception (DRX) configuration that indicates a DRX on-duration for data communication and an energy harvesting (EH) configuration that indicates a reserved EH duration during which a first device harvests energy and does not transmit or receive data, wherein the DRX on-duration and the reserved EH duration are part of a periodic cycle; performing data communication during the DRX on-duration; and transmitting energy to the first device during the reserved EH duration.
Aspect 21: The method of Aspect 20, further comprising transmitting an indication of a maximum length for the DRX on-duration, and wherein the DRX configuration specifies that the DRX on-duration cannot exceed the maximum length.
Aspect 22: The method of Aspect 20 or 21, further comprising transmitting an indication to use a dedicated resource in the reserved EH duration.
Aspect 23: The method of any of Aspects 20-22, further comprising transmitting an update to the EH configuration that is based at least in part on one or more of a quantity of neighboring devices, channel state information, a frequency range, or a beamforming gain.
Aspect 24: The method of any of Aspects 20-23, wherein transmitting the DRX configuration includes transmitting the DRX configuration in a wake-up message.
Aspect 25: A method of wireless communication performed by a first device, comprising: receiving a discontinuous reception (DRX) configuration that indicates a DRX on-duration for data communication and an energy harvesting (EH) configuration that indicates an EH duration during which the first device harvests energy, wherein the DRX on-duration and the EH duration partially overlap or fully overlap; performing data communication during the DRX on-duration; and splitting power of the first device to also perform EH during the EH duration.
Aspect 26: The method of Aspect 25, further comprising transmitting an indication of the EH duration in a wake-up message.
Aspect 27: The method of Aspect 25 or 26, further comprising transmitting one or more power splitting factors for splitting power between the DRX on-duration and the EH duration.
Aspect 28: The method of any of Aspects 25-27, further comprising transmitting an indication of one or more time gaps in association with one or more wake-up messages.
Aspect 29: A method of wireless communication performed by a second device, comprising: transmitting a discontinuous reception (DRX) configuration that indicates a DRX on-duration for data communication and an energy harvesting (EH) configuration that indicates an EH duration during which a first device harvests energy, wherein the DRX on-duration and the EH duration partially overlap or fully overlap; performing data communication during the DRX on-duration; and transmitting energy during the EH duration.
Aspect 30: The method of Aspect 29, further comprising transmitting an indication of the EH duration in a wake-up message.
Aspect 31: An apparatus for wireless communication at a device, comprising a processor; memory coupled with the processor; and instructions stored in the memory and executable by the processor to cause the apparatus to perform the method of one or more of Aspects 1-30.
Aspect 32: A device for wireless communication, comprising a memory and one or more processors coupled to the memory, the one or more processors configured to perform the method of one or more of Aspects 1-30.
Aspect 33: An apparatus for wireless communication, comprising at least one means for performing the method of one or more of Aspects 1-30.
Aspect 34: A non-transitory computer-readable medium storing code for wireless communication, the code comprising instructions executable by a processor to perform the method of one or more of Aspects 1-30.
Aspect 35: A non-transitory computer-readable medium storing a set of instructions for wireless communication, the set of instructions comprising one or more instructions that, when executed by one or more processors of a device, cause the device to perform the method of one or more of Aspects 1-30.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A first device for wireless communication, comprising:
a memory; and
one or more processors, coupled to the memory, configured to:
receive a discontinuous reception (DRX) configuration that indicates a DRX on-duration for data communication and an energy harvesting (EH) configuration that indicates a reserved EH duration during which the first device harvests energy and does not transmit or receive data, wherein the DRX on-duration and the reserved EH duration are part of a periodic cycle;
perform data communication during the DRX on-duration;
switch one or more antennas of the first device to an EH mode; and
perform EH during the reserved EH duration.

2. The first device of claim 1, wherein the reserved EH duration does not overlap with the DRX on-duration.

3. The first device of claim 1, wherein the DRX configuration specifies that an inactivity timer associated with the DRX on-duration ends before the reserved EH duration.

4. The first device of claim 1, wherein the one or more processors are configured to receive an indication of a maximum length for the DRX on-duration, and wherein the DRX configuration specifies that the DRX on-duration cannot exceed the maximum length.

5. The first device of claim 1, wherein the EH configuration specifies a dedicated resource within the reserved EH duration to be used for a dedicated source of energy.

6. The first device of claim 5, wherein the EH configuration specifies a time between the dedicated resource and another dedicated resource.

7. The first device of claim 5, wherein the EH configuration specifies an undedicated resource within the reserved EH duration that is available for using a source of energy other than the dedicated source of energy.

8. The first device of claim 5, wherein the one or more processors are configured to receive an indication to use the dedicated resource in the reserved EH duration.

9. The first device of claim 8, wherein the indication includes one or more of a target power, a target charging rate, an energy request, or a target device for energy.

10. The first device of claim 8, wherein the indication includes one or more of a suggested component carrier, a suggested bandwidth part (BWP), or a suggested combination of frequency band and BWP.

11. The first device of claim 8, wherein the one or more processors, to receive the indication, are configured to receive the indication in a wake-up message.

12. The first device of claim 8, wherein the indication indicates one or more of the reserved EH duration, EH cycle information, quasi-co-location information for EH, or an extended dedicated resource duration.

13. The first device of claim 1, wherein the DRX configuration or the EH configuration specifies a time gap between an end of the DRX on-duration and a start of a resource within the reserved EH duration.

14. The first device of claim 1, wherein the DRX configuration or the EH configuration specifies that there is to be no active time extension for the DRX on-duration during the reserved EH duration.

15. The first device of claim 1, wherein the one or more processors are configured to receive one or more of a configured grant or an indication to activate a dedicated resource in response to transmitting an EH request at least a specified quantity of symbols before another DRX on-duration.

16. The first device of claim 1, wherein the EH configuration is based at least in part on a type of the first device.

17. The first device of claim 1, wherein the one or more processors are configured to receive an update to the EH configuration that is based at least in part on a quantity of neighboring devices, channel state information, a frequency range, or a beamforming gain.

18. The first device of claim 17, wherein the one or more processors are configured to transmit user assistance information, physical channel feedback, or an energy request, and wherein the one or more processors, to receive the update, are configured to receive the update during the DRX on-duration.

19. The first device of claim 1, wherein the one or more processors, to receive the DRX configuration, are configured to receive the DRX configuration in a wake-up message.

20. A second device for wireless communication, comprising:
a memory; and
one or more processors, coupled to the memory, configured to:
transmit a discontinuous reception (DRX) configuration that indicates a DRX on-duration for data communication and an energy harvesting (EH) configuration that indicates a reserved EH duration during which a first device harvests energy and does not transmit or receive data, wherein the DRX on-duration and the reserved EH duration are part of a periodic cycle;
perform data communication during the DRX on-duration; and
transmit energy to the first device during the reserved EH duration.

21. The second device of claim 20, wherein the one or more processors are configured to transmit an indication of a maximum length for the DRX on-duration, and wherein the DRX configuration specifies that the DRX on-duration cannot exceed the maximum length.

22. The second device of claim 20, wherein the one or more processors are configured to transmit an indication to use a dedicated resource in the reserved EH duration.

23. The second device of claim 20, wherein the one or more processors are configured to transmit an update to the EH configuration that is based at least in part on one or more of a quantity of neighboring devices, channel state information, a frequency range, or a beamforming gain.

24. The second device of claim 20, wherein the one or more processors, to transmit the DRX configuration, are configured to transmit the DRX configuration in a wake-up message.

25. A first device for wireless communication, comprising:
a memory; and
one or more processors, coupled to the memory, configured to:
receive a discontinuous reception (DRX) configuration that indicates a DRX on-duration for data communication and an energy harvesting (EH) configuration that indicates an EH duration during which the first device harvests energy, wherein the DRX on-duration and the EH duration partially overlap or fully overlap;
perform data communication during the DRX on-duration; and
split power of the first device to also perform EH during the EH duration.

26. The first device of claim 25, wherein the one or more processors are configured to transmit an indication of the EH duration in a wake-up message.

27. The first device of claim 25, wherein the one or more processors are configured to transmit one or more power splitting factors for splitting power between the DRX on-duration and the EH duration.

28. The first device of claim 25, wherein the one or more processors are configured to transmit an indication of one or more time gaps in association with one or more wake-up messages.

29. A second device for wireless communication, comprising:
a memory; and
one or more processors, coupled to the memory, configured to:
transmit a discontinuous reception (DRX) configuration that indicates a DRX on-duration for data communication and an energy harvesting (EH) configuration that indicates an EH duration during which a first device harvests energy, wherein the DRX on-duration and the EH duration partially overlap or fully overlap;
perform data communication during the DRX on-duration; and
transmit energy during the EH duration.

30. The second device of claim 29, wherein the one or more processors are configured to transmit an indication of the EH duration in a wake-up message.
